(19) United States
(12) Patent Application Publication
(10) Pub. No.: US 2025/0339833 A1
(43) Pub. Date: Nov. 6, 2025

(54) Novel High-Efficiency Plasma/Pyrolytic Gas-phase Reactor with Enhanced Neutralization Capability

(71) Applicants: Bruce Freeman, Lincoln, CA (US); Peter Renteln, Kenvil, NJ (US)

(72) Inventors: Bruce Freeman, Lincoln, CA (US); Peter Renteln, Kenvil, NJ (US)

(73) Assignee: Icarus Thermal Solutions, Kenvil, NJ (US)

(21) Appl. No.: 19/266,644

(22) Filed: Jul. 11, 2025

(51) Int. Cl. B01J 19/08; H05H 1/18; H05H 1/46

(52) U.S. Cl. CPC B01J 19/088; H05H 1/18; H05H 1/4652; B01J 2219/0801; B01J 2219/0869

(57) ABSTRACT

A gas-phase reactor system for dissociating and reacting gas-phase molecules employs a novel combination of plasma and pyrolytic energy to achieve up to 500 times greater dissociation efficiency compared to existing plasma, pyrolytic, catalytic, or water-based remediation systems. Integrated with an adsorption bed, the system neutralizes and captures dissociated elements and molecular fragments to levels below 1 part per billion. The reactor's innovative design eliminates the need for downstream water scrubbing, carrier gases, plasma-enhancing gases, additional heat, or catalytic inputs, enabling true point-of-use remediation. This results in up to a 10-fold reduction in cost of ownership and facility footprint compared to conventional centralized remediation systems, offering a compact, efficient, and cost-effective solution for gas-phase molecular processing.

### BACKGROUND OF THE INVENTION

Industrial processes such as semiconductor etch and deposition produce hazardous exhaust gases which require remediation for both environmental and safety concerns. Remediation of such gases is commonly done today in a variety of ways, including pyrolytic burn wash and plasma abatement systems. Such systems use pyrolytic, plasma, catalytic and water-based methods to achieve up to 99.99% dissociation and remediation up to 0.005 ppm for common industrial process gases like SF₆. However, for more difficult-to-dissociate gases like WF6 these systems may achieve only 96% dissociation. Further, existing systems rely on ancillary infrastructure which puts a strain on factory and environmental resources. For a typical production fab, such systems consume invaluable space and result in a significant increase in the cost of operation. These additional highly complex subsystems also multiply the number of failure points, further eroding uptime and draining valuable support resources.

Current growth in the semiconductor industry will encourage global regulatory agencies to reduce allowable emissions levels of hazardous and greenhouse exhaust gases. This global trend will drive the demand for better performing environmentally friendly remediation systems that use less energy, water and gas, and operate at a lower cost of ownership.

### SUMMARY OF THE INVENTION

A gas-phase reactor for dissociating and reacting gas-phase molecules, and an adsorption bed capable of neutralizing and capturing dissociated elements and molecular fragments to a simulated level of <1 ppb. The use of a plasma together with pyrolytic energy, dissociates gas molecules up to 500 times more effectively than known existing combinations of plasma, pyrolytic, catalytic and water-based remediation systems.

When considering the ancillary requirements of known remediation technology, the reactor of this disclosure operates at significant advantage, saving up to 10× on the cost of ownership and facility footprint. The novel design of this reactor eliminates the need for downstream water scrubbing of post reacted elements and additional process consumables such as carrier or plasma enhancing gases. It requires no additional heat or catalytic inputs and enables true point-of-use individual process remediation as compared to a more centralized system which requires additional infrastructure such as carrier gases, wet scrubbers and complex catalytic beds.

### BRIEF DESCRIPTION OF DRAWINGS

Turning now descriptively to the drawings, in which similar reference characters denote similar elements throughout the several views, the figures illustrate the electronic book of the present invention. With regard to the reference numerals used, the following numbering is used throughout the various drawing figures.

FIG. 1 illustrates a high-efficiency plasma/pyrolytic remediation reactor with various components for gas dissociation and neutralization.

FIG. 2 Two side views of a porous media disc configured with sealant on the circumference, and upper and lower zirconia tubes.

FIG. 3 illustrates a multi-gas-phase reactor system with control valves and rf coil components.

FIG. 4 illustrates a magnetron-powered high-efficiency plasma/pyrolytic gas-phase reactor demonstrating various components and their interconnections.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

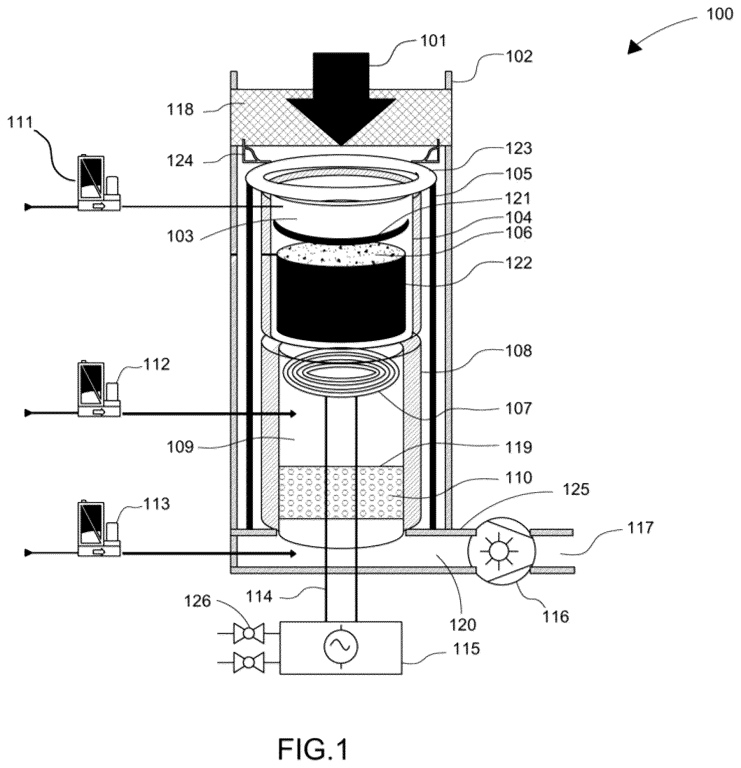

FIG. 1 illustrates a high-efficiency plasma/pyrolytic remediation reactor with various components for gas dissociation and neutralization.

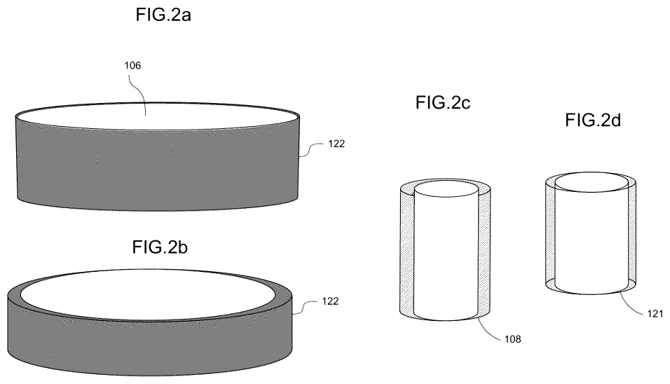

FIG. 2 Two side views of a porous media disc configured with sealant on the circumference, and upper and lower zirconia tubes.

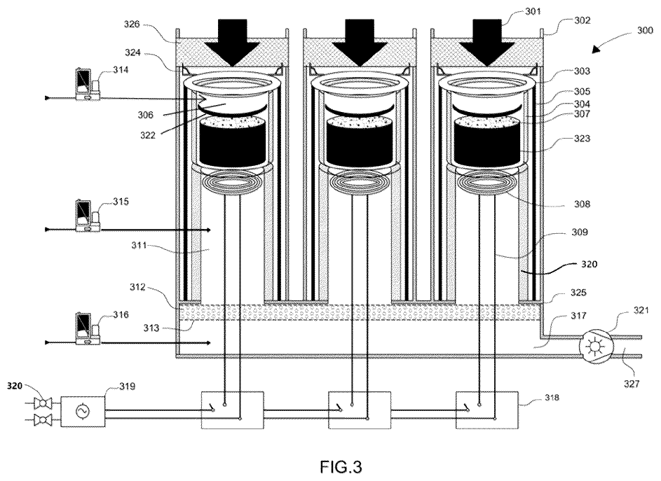

FIG. 3 illustrates a multi-gas-phase reactor system with control valves and rf coil components.

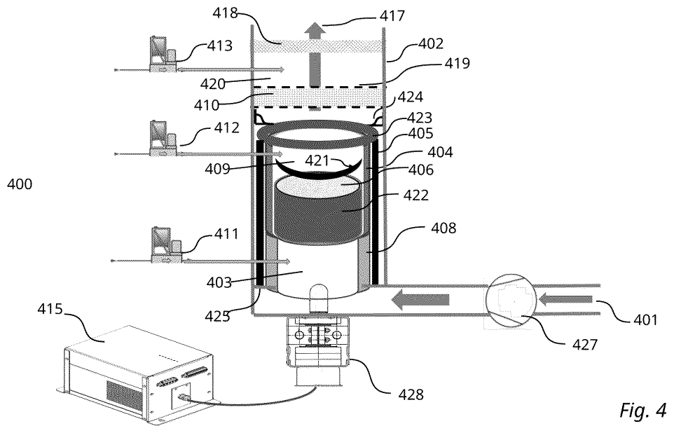

FIG. 4 illustrates a magnetron-powered high-efficiency plasma/pyrolytic gas-phase reactor demonstrating various components and their interconnections.

A gas-phase reactor for dissociating and reacting gas-phase molecules is disclosed. Dissociation of a molecule is the process of breaking all the chemical bonds of the molecule into individual atoms. Bonds of a molecule may exist such that each atom of the molecules is bound only to one or two other atoms such as nitrogen, in which each nitrogen atom is bound to the other, or the bonds may exist such that one or more atoms of the molecule is chemically bound to more than two atoms, as is the case with glucose, in which the end carbons are bonded not only to other carbons but also to hydrogen and oxygen elements. Further, the bonds comprising a molecule may be of different types. The bonds could be ionic, covalent or metallic. Complete dissociation occurs when all bonds, regardless of type, have been broken. For example, nitrogen could be dissociated into two individual nitrogen atoms, while glucose could be dissociated into individual carbon, oxygen and hydrogen atoms.

Two methods of dissociation include high temperature, called “pyrolytic” and bombardment with electrons, sometimes referred to as “plasma dissociation”. Additional methods of dissociation include collision with other elements, ions or molecules, and collisions with solid objects. In cases where dissociation alone is the desired outcome, electron bombardment can be a more energy efficient method of dissociation, since high temperatures can be energy demanding. Further, for some molecules, only very high temperatures such as 1800° C. can bring about complete dissociation.

The creation of a plasma, which is a gas cloud of ions and electrons, can be very useful to bring about dissociation. The electrons in a plasma have very high energy and when those electrons collide with molecules, they can create dissociation. In some cases, a single electron-molecular collision may fracture the molecule into other, smaller molecules. Further, repeated collisions can succeed in completely dissociating molecules. The effectiveness of dissociation includes the electron density (ne) of the plasma and the energy of the electrons.

An Electro Magnetic source (EMS) is capable of generating an Electro Magnetic Field (EMF) in the range of 100 kHz to 10 GHz. The choice of frequency for plasma generation depends on the system design and gas properties. Radio Frequency (RF) in the range of 100 kHz to 1 MHz supports plasma in applications like dielectric barrier discharges, often at atmospheric pressure. Radio Frequency (RF) in the range of 1 MHz to 100 MHz is commonly used in industrial plasma applications. Microwaves (MW) in the 300 MHz to 10 GHz range are suitable for higher energy plasmas. RF generally offers uniform plasma for consistent dissociation, while microwaves provide higher electron energies for dissociation of more complex gases.

It is desirable to maximize dissociation of target molecules. However, in some cases, dissociation is not complete, but rather, leads to molecular fragments which also may be toxic. Therefore, it is further desirable to completely dissociate undesirable molecules into their atomic constituents. One type of undesirable molecule is residual gas emanating from a plasma etch reaction used in the semiconductor industry. Other types of undesirable molecules include residual SO2 and NOx from the burning of coal. It is therefore desirable to increase the effectiveness of plasma dissociation. One way to make the plasma more effective is by increasing the frequency of the plasma. For example, a 2.45 GHZ plasma is more effective than a 13.56 MHz plasma. The higher frequency increases the electron oscillation rate, allowing more opportunities for collisions with gas molecules per unit time. Further, a higher frequency results in improved coupling efficiency with the plasma. For example, 2.45 GHz offers some 90% coupling efficiency compared to the coupling efficiency at 13.56 MHz of around 50%-70%. This increased efficiency reduces specific energy from 2-4 kJ per liter to about 0.15 kJ per liter, and therefore reduces the energy cost of dissociation.

Another method of increasing plasma effectiveness is to modulate the EMF signal. By using the same average power, a pulsed power at 50% duty cycle is twice as much power during the on cycle. For example, a pulsed signal may have 2 kW of power during the “on” cycle and zero kW during the “off” cycle, giving the total time-averaged signal a power of 1 kW. The higher power generates a stronger E field, accelerating electrons faster, increasing ionization and producing more electrons per collision. The higher E-field causes an avalanche effect, where each electron-ion pair generates additional pairs, boosting ne. The electron density is mostly maintained during the “off” cycle due to long recombination timescales.

In addition to the electron density and energy of the excited electrons, another factor which supports molecular dissociation is the residence time of the molecule. The longer the molecule is present in the plasma, the more electron-molecule collisions can take place. A higher number of collisions can translate into more complete dissociation. Conversely, the less time a molecule spends in the plasma, the less complete the dissociation will tend to be. Therefore, if the desired outcome is greater molecular dissociation, it is advantageous to both maximize the field strength and increase the residence time of the molecules.

Another method of further improving molecular dissociation is to combine the effect of a plasma together with a pyrolytic effect. The dissociation effect of a pyrolytic system can be made to add to the dissociation effects of plasma system. A pyrolytic effect can be administered by the presence of a hot object placed inside the plasma. The object could have a solid monolithic morphology that is not gas permeable. When molecules collide with the monolithic object, they will gain energy as a result of the collision, and dissociation will be improved. Alternatively, if the object were to be gas-permeable, then it could serve two purposes. One is that it could slow the passage of molecules thereby increasing residence time, and two is that if the gas-permeable object is made hot, it could contribute to dissociation.

To achieve a longer residence time, a porous, gas-permeable (referred to henceforth as “porous”) material can be placed in an interfering position in a waveguide. While the undesirable (target) gas is motivated down the waveguide, it must pass through the porous material. The porous material then serves to retard the progress of the gas. If an EMF signal can be made to permeate the porous material, the residence time of the target gas in the plasma can be increased.

Further, it will be apparent to those skilled in the art, an optional chemical configuration that alters the absorption coefficient of the porous material will change the ratio of plasma strength to pyrolysis effect. If the material is made to absorb more EMF energy, it will become hotter, increasing pyrolysis, increasing the ratio of pyrolysis effect to EMF effect. Decreasing EMF absorption results in the opposite effect. In this way, the process can be “tailored” with different designs to alter the ratio of pyrolytic dissociation to plasma-induced dissociation.

The porous material must be sufficiently porous to be gas permeable. It is clear to one skilled in the art that such a porous material could be more porous than necessary to be gas permeable. In this event, the gas residence time would be lower than if the porosity were less. By controlling the porosity of the porous material above that porosity needed to achieve gas-permeability, then, the residence time can be tailored to optimal outcome. A shorter residence time will result in less dissociation but can provide a greater maximum flow rate, while a longer residence time may result in greater dissociation but may result in a lower maximum flow rate.

The porous material may be constructed of a sintered ceramic of particles sufficiently large to create porosity and gas permeability. It could be considered that a particle size of greater than 50 microns would be sufficient to allow for gas permeability, although different sintering conditions could allow a smaller particle size. Alternatives to sintered particles include a cluster of ceramic particles or pellets, held in place by a ceramic cage. The particles may comprise polyhedral-shaped elements, spherically-shaped elements, fractal-shaped elements, or comprised of pellets held together by sintering, a bonding agent, or a ceramic screen. A 3D-printed lattice structure could also be considered.

Optimal molecular dissociation requires significant EMF permeation of the porous material and a means to guide target molecules through the porous material. A configuration which satisfies these requirements is a waveguide, inside of which the porous material is configured such that the molecules must pass through the porous material. The EMF emitter could be inside the waveguide or outside, but the porous material must be permeated by the EMF signal. There must be a means to motivate the gas through the EMF-permeated porous material. A pressure differential on opposite sides of the porous material, or, for example, an electric field in the direction of the length of the waveguide could provide such means.

The porous material serves additional purposes toward dissociation. As long as the index of refraction of the porous material is greater than unity, then sharp edges occurring at the intersection of pores or in locations where sintered particles contact each other serve to enhance the field strength. Enhanced field strength will dramatically increase ionization and therefore electron density in the plasma. This significantly increases electron-molecule collisions and therefore significantly enhances dissociation. Further, by raising field strength within each pore, the EMF is made more uniform across the entirety of the porous material. Regardless of where in the waveguide the target gas traverses the porous material, it will be subject to a field which is similar in strength to the target gas traversing in another location. This is not the case for a plasma that is established within a guided passageway in open space. In that event, the plasma density varies considerably across the passageway.

In order to replicate the effect of higher field strength by virtue of sharp edges within the porous material when using 3D printing, generally higher resolution than is normally available in standard 3D printing is required. To achieve the sharp edges which enhance field strength, 3D printing based on more advanced techniques such as Fused Deposition Modeling (FDM) or standard Stereolithography (SLA), which have resolutions in the range of 50-200 microns may be required. If such techniques are insufficient, yet higher resolution techniques such as Two-Photon Polymerization (2PP) or Projection Micro-Stereolithography (PμSL) which can achieve resolutions down to 1-10 microns may be required.

After the target molecules become dissociated by virtue of passing through the porous material immersed in an EMF, then it is necessary to capture the elemental forms of some of the materials before recombination occurs. For some molecules such as oxygen and nitrogen, recombination is not an issue and prevention is not required. But for many elemental substances, for example, the halides or heavy metals, capture before recombination is desirable to achieve complete remediation. In order to prevent recombination, therefore, an adsorptive bed is placed in the path of the dissociated molecules after passage through the porous structure. An example of an adsorptive bed includes calcium carbonate (CaCO₃), which reacts with elemental forms of many species, typically creating molecules of minimal toxicity which are more readily disposed of.

In light of the aforementioned description, the following is an embodiment of the present invention, incorporating a guided metallic housing surrounding an interior passageway, with both a gas inlet and a gas outlet, providing a configuration which allows for the controlled entry and exit of gases through the reactor. The design ensures efficient flow and dissociation of gas molecules, contributing to the overall effectiveness of the remediation process. Within the housing, a porous material is immersed in the field of an EMF high frequency emitter. The porous material can comprise hexagonal Boron Nitride (hBN).

In a further embodiment, an alternative configuration comprises multiple reactor exhaust outlets feeding into a singular contiguous adsorptive bed. The absorptive bed is in intimate contact with a stainless-steel manifold plate that supports multiple reactors, ensuring that no dissociated elements can mix with elements from other reactors without first passing through a sufficient thickness of absorptive material. After passing through the adsorptive bed, residual elements and molecules from all reactors are exhausted through a common port.

The porous media also has multiple requirements. Due to exposure to the plasma, the porous media will heat to pyrolytic levels (above 1000° C.). The material must be able to withstand the elevated temperature without deformation or degradation. Further, the material must also be very resistant to plasma damage. Additionally, in one embodiment, the porous media has the lowest possible absorption coefficient so as to minimize the direct energy absorbed from the EMF. By keeping EMF absorption low, the media is minimally heated by the EMF, maximizing the percentage of plasma dissociation.

In alternative embodiments, the chemical configuration of the material can be engineered to alter the amount of EMF field absorbed by the disc, thereby altering the steady-state temperature of the media when the excitation source is on. At this higher temperature, the media will exhibit a greater pyrolytically effect than if the absorption coefficient is low. This greater pyrolytic effect can be advantageous if the objective of the invention is not only remediation, but production of carbon by-products as well. If boron nitride is used as the media material and CO₂ is the target gas to be remediated, the crystalline structure of the BN will encourage the formation of carbon-based by-products that contain the SP₂ bond such as carbon nanotubes and graphene.

In a further embodiment, pursuant to the inventive concepts presented herein, the radio-frequency (RF) coil is engineered to operate at a power output level of 1.5 kilowatts (kW) paired with an operating frequency set at 13.56 megahertz (MHz). Operating at 13.56 MHz can be beneficial because of its established presence in EMF applications which guarantees the availability of a broad range of compatible components and supplementary equipment. This frequency also diminishes the potential for interference with other communication devices, typically functioning at alternate frequencies. Further, the RF generated at 13.56 MHz will more uniformly penetrate a ceramic porous media. Alternatively, other allowed frequencies could be selected, such as 27.12 MHz, 915 MHZ, and 2.45 GHZ. At the 13.56 MHz frequency, the RF coil is composed of a material designed to exhibit inductance and capacitance characteristics that resonate. The coil's structure is designed to ensure continuous operation at a power level of 1.5 KW without overheating or experiencing a decline in performance over extended periods. To manage thermal output during intensive power applications, cooling solutions have been integrated into the coil architecture. In one embodiment, the coil comprises a copper tubing suitable for flowing a coolant through it.

Alternative porous media and coil constructions can be contemplated. For example, an additional porous media can be placed below the coil such that the field generated by the coil permeates both the lower and upper porous media. Additionally, the system could be configured with the coil surrounding the circumference of the porous media.

The reactor is encased in a ceramic housing to channel the EMF field and provide thermal insulation. In one embodiment, the ceramic housing is a Zirconia (ZrO₂) tube, providing a high-temperature material which also acts as an insulator. Zirconia's high dielectric constant (^{˜}20-30) enhances evanescent field intensity near the wall, which is especially useful for plasma ignition and boundary-layer reactions. Zirconia also supports circular symmetry with TE₀₁ and TE₁₁ hybrid modes, and enables passive impedance matching, eliminating the need for tuners, or matching networks.

Outside of the upper and lower zirconia tubes, insulation is required to keep the temperature of the stainless-steel housing within safety limits. Carbon felt insulation is a high-temperature material which can be used to maintain the stainless-steel housing temperature below safety limits. A carbon felt material can be wrapped around the zirconia to thermally insulate the reactor and its components from the stainless-steel housing. The felt also serves to provide a compressive force between the zirconia and the stainless-steel, which keeps the zirconia in place.

The Thermal Coefficient of Expansion (TCE) of hBN media is less than the TCE of the zirconia, so upon an increase in temperature, a gap will form between the outer circumference of the hBN and the inner circumference of the zirconia. This gap could allow gases to travel directly to the bottom of the gap, bypassing the bulk of the hBN disc and avoiding proper dissociation. To mitigate this effect, a lower zirconia tube is situated below the hBN disc which has a smaller inner diameter than the upper zirconia tube. The hBN disc sits on top of the lower tube. During expansion, when a gap forms between the hBN and the upper zirconia, the gas will not be able to penetrate the seal formed by hBN and the lower zirconia tube.

However, even though the gas will be unable to penetrate the seal formed between the hBN and the lower zirconia tube, gas molecules could still avoid most of the hBN thickness by traveling from the lower portion of the hBN/zirconia gap through a short segment length of the hBN, thereby escaping the bulk of the hBN traverse. In order to avoid gas from entering the hBN from the side, the outer circumference of the hBN can be sealed with a high-temperature sealant. To ensure that the hBN/lower zirconia interface is sealed, we can extend the sealant of the hBN circumference to the outer portion of the lower face of the hBN disc. Then the solid, non-porous lower face of the hBN media is in intimate contact with the upper edge of the lower zirconia tube, ensuring a good gas seal between them.

An optional carrier gas such as nitrogen (N₂), may be useful in the plasma remediation reactor to aid in moving the exhaust gas through the reactor. By introducing the carrier gas at a certain flow rate, it helps maintain a steady and controlled flow of gases. This ensures that the exhaust stream makes effective contact with the hBN disc, allowing for optimal dissociation of hazardous molecules. The carrier gas acts as a medium to transport other gases through each stage of the reactor, enhancing its overall efficiency. Further, the carrier gas serves as a heat transfer medium to stabilize the temperature of components within the reactor.

In certain industrial exhaust processes, a substantial level of particles is often entrained within the exhaust gases. To address this concern, it is recognized by those having ordinary skill in the art that these entrained particles can be effectively removed prior to introduction into the reactor by implementing a pre-filter or pre-trap positioned at the reactor inlet. The adoption of such pre-filters is considered advantageous for protecting internal components of the reactor from potential contamination or blockage, thereby enhancing the performance and longevity of the reactor system.

Considering dissociation of example semiconductor etch gases, the resultant dissociated elements may recombine into reactive and corrosive or environmentally harmful products. For example, dissociated SF₆ elements may contain Sulfur(S) and Fluorine (F). These elements may recombine to form S₂ and F₂. Carbon (C) and Fluorine (F) elements from CF₄ may recombine to form CF₂. Hydrogen (H) and Bromine (Br) elements from HBr may recombine to form H₂ and Br₂. Silicon (Si) and Fluorine (F) elements from SiF₄ may recombine to form SiF₂, SiF and F₂. Both elemental forms of component molecules as well as recombined forms are mostly captured by the CaCO₃ bed. To achieve the highest levels of remediation, it is advantageous to adsorb elements before recombination occurs and therefore the placement of the CaCO₃ bed must be optimized.

The adsorption bed seizes and neutralizes these dissociated species. Through this interaction, it converts them into stable compounds like CaF₂, CaBr₂, CaCl₂) salts, thus markedly diminishing harmful emissions and obstructing recombination. Example reactions include the following: Fluorine forms calcium fluoride, a stable, insoluble solid. Sulfur forms calcium sulfide or calcium sulfate (CaS, CaSO₄), both stable solids, immobilizing the sulfur. CaSO₄ (gypsum) is environmentally benign. Bromine (Br) forms calcium bromide.

In a further embodiment of the present invention, an optional vacuum source may be utilized to create a controlled pressure differential across the gas-permeable hBN media and to promote the movement of exhaust gases through the adsorbent media subsequent to dissociation. The employment of a vacuum source can serve to lower the ambient pressure in proximity to the adsorbent material, thereby augmenting the flow of exhaust gases across the media bed due to an increased vapor pressure gradient. A liquid-ring vacuum source, serving as the backing pump, may be incorporated to introduce an additional washing stage into the remediation process, which would enhance the overall gas cleaning efficacy by capturing any remaining particulates or soluble dissociated species.

FIG. 1 illustrates an embodiment of reactor 100 for a single exhaust stream. Reactor 100 comprises a stainless-steel housing 102 defining a guided upper interior volume 103 within upper zirconia tube 104. The reactor has at least one gas inlet 101 and at least one gas outlet 117. hBN porous ceramic disc 106 (for example, as supplied by EdgeTech Industries, Tamarak, Florida) is disposed within guided upper interior volume 103, and geometrically configured such that all of the gas must pass through hBN porous ceramic disc 106. hBN porous ceramic disc 106 is held in place by leaf spring 121 and has a sealant 122 around the circumference. It should be understood that in FIG. 1, the narrow open spaces as depicted between hBN porous ceramic disc 106 and upper zirconia tube 104, between the upper and lower zirconia tubes and carbon fiber insulation layer 105 and stainless-steel housing 102 and between carbon fiber insulation layer 105 do not exist at room temperature. The arrangement is understood to be a snug fit, although at elevated temperature, due to differing coefficients of thermal expansion, it is possible that a gap between the hBN and the upper zirconia will appear.

Carbon fiber insulation layer 105 surrounds the upper and lower zirconia tubes to thermally insulate them from stainless-steel housing 102. The carbon fiber insulation layer 105 is held in place by carbon graphite gasket 123 which is secured by the outside diameter of upper zirconia tube 104. The upper edge of carbon fiber insulation layer 105 is sealed from exhaust gases by carbon graphite gasket 123. Downward pressure on carbon graphite gasket 123 is applied by spring latch 124. One or a plurality of spring latches are disposed around the circumference of the gasket.

A RF coil 107 suitable for carrying high frequency EMF power and a coolant (for example, copper tubing) is positioned below hBN porous ceramic disc 106, and powered by a 1.5 kW, 13.56 MHZ RF generator 115 through RF connecting tubes 114 to generate a plasma field and maintain temperature. The generated field extends beyond the boundaries of the BN disc. The field generated by the coil is further contained by a lower Zirconia tube 108. The dimensions of upper zirconia tube 104 and lower zirconia tube 108 are such that the outer diameters are identical while the inner diameter of lower zirconia tube 108 is smaller than the inner diameter of upper zirconia tube 104 and also smaller than the diameter of hBN porous ceramic disc 106. In this way, hBN porous ceramic disc 106 rests on the top rim of lower zirconia tube 108. hBN porous ceramic disc 106 is held stationery by the effect of downward pressure supplied by spring latch 124 situated above carbon graphite gasket 123. This pressure serves to seal the upper and lower zirconia tubes to prevent exhaust gas from escaping from the guided interior volume without fully passing through the hBN disc. The downward pressure vertically compresses lower zirconia tube 108 against stainless-steel plate 125. Additional field containment is realized by the placement of copper mesh 118 surrounding stainless-steel housing 102 between gas inlet 101 and exterior equipment.

A carrier gas (e.g., N₂ at 20 SLM) is optionally introduced into guided upper interior volume 103 via flow regulator 111 to motivate gas flow through hBN porous ceramic disc 106. Optionally, reactive gases are introduced via flow regulator 112 into guided middle interior volume 109 after plasma dissociation to help reduce atomic recombination. If a gas with sufficiently high ionization efficiency such as Argon is injected, the plasma can be supported below the coil from the RF field provided by the coil. Such a plasma will discourage recombination by virtue of ionizing some of the elemental fragments, causing them to repel each other.

A CaCO₃ adsorption bed 110 (1-2 mm pellets, as available from Grower's Solution, Cookeville, TN) contained by a stainless-steel mesh screen 119 is positioned below RF coil 107 at a distance to minimize the effect of the RF field on CaCO₃ adsorption bed 110. The bed operates at elevated temperatures (from plasma/pyrolysis, it could rise in temperature to ˜600-1200° C. This leverages CaCO₃'s reactivity and decomposition properties to trap by-products effectively.

An additional optional purge gas can be introduced into guided lower interior volume 120 via flow regulator 113 after CaCO₃ adsorption bed 110 to assist with gas flow and react with residual active species. The gas flow can be enhanced by the presence of an optional liquid-ring pump 116, which both contributes to a pressure drop across the reactor, and mixes the exhaust flow with water, which can help remediate residual acids.

FIG. 2. Shows detailed images of a further embodiment of the hBN media with upper and lower zirconia tubes. FIG. 2a shows the side view of hBN porous ceramic disc 106 and sealant 122 covering the outer circumference. Sealant 122 wraps around the bottom edge to the bottom face of the media and extends 6.5 mm inward. The sealant is applied to the porous media and may penetrate into the media by several pore diameters. FIG. 2b illustrates lower zirconia tube 108, and in the present embodiment is 150 mm tall, has an OD of 97 mm and an ID of 63 mm. lower zirconia tube 108 wall is therefore 17 mm thick. FIG. 2c illustrates upper zirconia tube 104, and in the present embodiment is 100 mm tall, has an OD of 97 mm and an ID of 77 mm. Upper zirconia tube 104 wall is therefore 10 mm thick.

FIG. 3 illustrates another embodiment of multi-exhaust reactor 300 for a plurality of exhaust streams, which may comprise different exhaust gases. The reactor comprises stainless-steel housing 302 defining a plurality of guided upper interior volumes 306, where it is to be understood that all individual tubes are identical. A plurality of gas inlets 301 feed into guided lower interior volume 317. A hBN porous ceramic disc 307 (for example, as supplied by EdgeTech Industries, Tamarak, Florida) is disposed within the interior volume of each single reactor, and geometrically configured such that all of the gas must pass through hBN porous ceramic disc 307. hBN porous ceramic disc 307 has a sealant 323 around the circumference. hBN porous ceramic disc 307 is surrounded by upper zirconia tube 304. It should be understood that in FIG. 3, the narrow open spaces depicted between hBN porous ceramic disc 307 and upper zirconia tube 304, and between upper zirconia tube 304 and carbon fiber insulation layer 305, and between carbon fiber insulation layer 305 and stainless-steel housing 302, do not exist. The arrangement is understood to be a snug fit.

Carbon fiber insulation layer 305 surrounds the upper and lower zirconia tubes to thermally insulate the interior volume from stainless-steel housing 302. hBN porous ceramic disc 307 is prevented from upward motion by leaf spring 322 which is secured by the interior circumference of upper zirconia tube 304. The upper edge of carbon fiber insulation layer 305 is sealed from exhaust gases by carbon graphite gasket 303. Downward pressure on the gasket is applied by spring latch 324. One or a plurality of spring latches are disposed around the circumference of the gasket.

An RF coil 308 suitable for carrying (for example, copper tubing) is positioned below each high temperature insulating disc. Each coil is independently controlled by individual control boxes 318. For a multi exhaust system, multiple coils are powered by a single 13.56 MHz RF generator 319 through manifolded RF connecting tube 309. Manifolded RF connecting tubes 309 carry both the RF signal to generate a plasma field as well as the coolant solution provided by control valves 320 to RF coil 308. The generated field extends beyond the boundaries of the BN disc, surrounding the disc. The field generated by the coil is further contained by a lower zirconia tube 310. The dimensions of the upper and lower zirconia tubes are such that the outer diameters are identical while the inner diameter of lower zirconia tube 310 is smaller than the inner diameter of upper zirconia tube 304 and also smaller than the diameter of hBN porous ceramic disc 307. In this way, hBN porous ceramic disc 307 rests on the upper rim of lower zirconia tube 310. Upper zirconia tube 304 is held stationery by the effect of downward pressure supplied by spring latch 324 situated above the carbon graphite gasket 303. This pressure serves to seal the upper and lower zirconia tubes to prevent exhaust gas from escaping through the interface between them. The downward pressure also vertically compresses lower zirconia tube 310 against stainless-steel manifold plate 325. Together, the components disallow gas from escaping the guided interior volume without passing through the full vertical height of the hBN disc. Additional field containment is accomplished by the placement of copper mesh 326 surrounding stainless-steel housing 302 between gas inlet 301 and exterior equipment. It is to be understood that each individual reactor of the multi-exhaust system is identical to the single-exhaust reactor in the single-exhaust system.

One or more gases, such as a carrier gas (e.g., N₂) are optionally introduced into guided upper interior volume 306 via flow regulator 314 to motivate exhaust gas flow through the disc. Additionally, one or more gases, such as reactive gasses can be introduced via flow regulator 315 into guided middle interior volume 311 after plasma dissociation to help reduce atomic recombination. A CaCO₃ adsorption bed 312 contained by a stainless-steel mesh screen 313 above and below the bed is positioned in intimate contact with stainless-steel manifold plate 325. The distance between CaCO₃ adsorption bed 312 and RF coil 308 is optimized to both minimize the effect of the RF field generated by the coils on the bed, and to minimize the distance from hBN porous ceramic disc 307 to the bed to prevent atomic recombination before reaching CaCO₃ adsorption bed 312. Stainless-steel manifold plate 325 is solid steel with hole cutouts of diameter equal to the diameter of the ID of the zirconia tubes and aligned with the reactors to allow the passage of gas. Each reactor is firmly affixed to stainless-steel manifold plate 325, providing structural integrity to multi-exhaust reactor 300.

An additional optional purge gas can be introduced into guided lower interior volume 317 via flow regulator 316 after CaCO₃ adsorption bed 312 to assist with gas flow and react with and neutralize residual active species. The gas flow can be enhanced by the presence of an optional liquid-ring pump 321, which both contributes to a pressure drop across the reactor and mixes the exhaust flow with water. Optional liquid-ring pump 321 helps exhausts gas through gas outlet 327 by creating a pressure drop across the reactor.

In additional embodiments, when employing alternative frequencies such as a 2.45 GHZ microwave power source, the reactor must be re-optimized. For example, a commonly used microwave power source is a magnetron, used in household microwave ovens. The magnetron provides a strong microwave field, but generally the field has a functional Gaussian distribution, such that the strength at the center is greater than the strength at the edges. If the distance of the magnetron from the porous media is such that one can optionally taper the porous media such that it is thinnest in the center and thicker at the edges to optimize the residence time of molecules in accordance with the plasma intensity pattern. The purpose of this optional geometric configuration is to optimize the residence time of the gas with the strength of the microwave field. If the EMF field strength is given as 100% at the center, then it can drop to 10% to 20% at 60 degrees from center line. By tapering the porous media, then, the residence time can be adjusted such that the gas has the longest residence time where the field is weakest and the shortest residence time where the field is strongest. Such a tailoring of the porous media shape is not required for an RF field of, say, 13.56 MHZ, since the field can be generated closer to the porous media and the field is more uniformly distributed.

FIG. 4 shows a preferred embodiment of the present disclosure in which a magnetron is used to generate a microwave field for the purpose of generating a plasma. Reactor 400 comprises a stainless-steel housing 402 defining a guided upper interior volume 420 within upper zirconia tube 404. The reactor has at least one gas inlet 401 and at least one gas outlet 417 that can be optionally backed by a facility scrubber (not depicted) maintaining a 0.5 atm pressure environment at the gas outlet 417. hBN porous ceramic media 406 (for example, as supplied by EdgeTech Industries, Tamarak, Florida) is disposed within guided upper interior volume 420, and geometrically configured such that all of the gas must pass through hBN porous ceramic media. hBN porous ceramic media 406 is held in place by leaf spring 421 and has a sealant 422 around the circumference. It should be understood that in FIG. 4. the narrow open spaces as depicted between hBN porous ceramic media 406 and upper zirconia tube 404, between the upper and lower zirconia tubes and carbon fiber insulation layer 405 and stainless-steel housing 402 and between carbon fiber insulation layer 405 do not exist at room temperature and are depicted only for clarity. The arrangement is understood to be a snug fit, although at elevated temperature, due to differing coefficients of thermal expansion, it is possible that a gap between the hBN and the upper zirconia tube 404 will appear.

Carbon fiber insulation layer 405 surrounds the upper and lower zirconia tubes to thermally insulate them from stainless-steel housing 402. The carbon fiber insulation layer 405 is held in place by carbon graphite gasket 423 which is secured by spring latch 424. One or a plurality of spring latches 424 are disposed around the circumference of the gasket.

A magnetron 428 as a suitable EMF emitter is positioned externally to the reactor and below the lower zirconia tube 408. The magnetron is optimally positioned so the magnetron probe extends into the guided lower interior volume 403, such that the lower zirconia tube 408 in combination with the stainless-steel housing 402 acts as a wave guide. The magnetron is powered by a dual mode PWM/PFM magnetron power supply 415 helping create a more uniform EMF distribution. This dual-mode control uses Pulse Width Modulation (PWM) and Pulse Frequency modulation (PFM) to smooth the energy delivery, which can stabilize plasma density, reduce thermal spikes, and optimize power consumption-especially in systems with variable gas flow or pressure.

The dimensions of upper zirconia tube 404 and lower zirconia tube 408 are such that the outer diameters are identical while the inner diameter of lower zirconia tube 408 is smaller than the inner diameter of upper zirconia tube 404 and also smaller than the diameter of hBN porous ceramic media 406. In this way, hBN porous ceramic media 406 rests on the top rim of lower zirconia tube 408. hBN porous ceramic media 406 is held stationery by the effect of downward pressure supplied by spring latch 424 situated above carbon graphite gasket 423. This pressure serves to seal the and zirconia tubes to prevent exhaust gas from escaping from the guided interior volume without fully passing through the hBN disc. The downward pressure vertically compresses lower zirconia tube 408 against the stainless-steel housing plate 425. Additional field containment is realized by the placement of copper mesh 418 surrounding stainless-steel housing 402 between gas inlet 401 and exterior equipment.

A carrier gas is optionally introduced into guided upper interior volume 420 via flow regulator 411 to help dilute and motivate remediated gases to the environment. More carrier gases such as nitrogen optionally introduced via flow regulator 412 into guided middle interior volume 409 post plasma dissociation to help reduce atomic recombination and motivate dissociated elements through the CaCO₃ adsorption bed 410. More gases such as argon and helium are optionally introduced via flow regulator 411 into guided lower interior volume 403 pre-plasma dissociation to enhance dissociation inside the plasma.

A CaCO₃ adsorption bed 410 (1-2 mm pellets, as available from Grower's Solution, Cookeville, TN) contained by a stainless-steel mesh screen 419 is positioned above the porous ceramic media at a distance to minimize the opportunity for dissociated gas molecules to recombine before adsorbing with the CaCO₃ adsorption bed 410, while simultaneously positioned far enough away from the microwave signal to avoid overheating.

### Example 1

The performance of the reactor shown in FIG. 4 has been modeled for remediation of various semiconductor gases. Remediation for a selection of gases is listed in Table 1, showing both post-porous media as well as post-adsorption results. The reactor configuration was as follows: Reactor Components: hBN Disk: 2.5″ diameter×2.25″ thick, 50% porosity, sintered with ˜50 μm pores. An EMS averaging 1.5 kW power generated by a 2.45 GHz frequency magnetron in pulsed mode (50 μs, 60% duty cycle, 2.5 kW peak) is mounted to 316 SS housing cylindrical waveguide with a 107 mm inner diameter. Inside the SS is a 10 mm thick Zirconia Wrap, surrounded by 10 mm thick carbon felt insulates the SS housing from the zirconia. A 12-liter CaCO₃ Bed comprised of 1-2 mm beads is located 2.5 cm below the hBN traps dissociated elements. The simulated results are provided in Table 1. The results suggest that all listed gases except CO₂ have a post-plasma dissociation of greater than 99.99% dissociation, and a post-adsorbent bed Destruction and Removal Efficiency (DRE) of 1 ppb.

Table 1. Select semiconductor gas remediation results from both post-plasma and post-adsorptive bed.

It is understood to one skilled in the art that this invention can be used for additional applications. For example, CO₂ can be dissociated into oxygen and carbon. One can scale the reactor dimensionally or combine them for higher volumes which would be necessary for industrial applications like coal combustion exhaust streams. Some industrial applications such as aluminum ore refining produce a toxic liquid byproduct that can be vaporized and dissociated by this reactor. Additionally, other industrial applications include splitting water or other hydrogen sources such as wastewater facilities conversion to hydrogen gas. Further, clean syngas (C₀+H₂) can be manufactured by modifying the process by replacing the CaCO₃ bed with a layered catalytic bed. Syngas can be cleaned by dissociating acidic gases (H₂S, COS) to elemental sulfur and hydrogen, recoverable as byproducts, and by dissociating NOx/NH₃ into N₂ and H₂. In general, this invention can be used to re-construct elements and molecules to create desirable and useful molecules after they have been dissociated.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

While there has been shown several and alternate embodiments of the present invention, it is to be understood that certain changes can be made as would be known to one skilled in the art without departing from the underlying scope of the invention as is discussed and set forth above and below. Furthermore, the embodiments described above are only intended to illustrate the principles of the present invention and are not intended to limit the scope of the invention to the disclosed elements.

1. A gas-phase reactor for dissociating gas-phase molecules, comprising:
a metallic housing surrounding a ceramic housing surrounding;
an interior passageway with a gas inlet and a gas outlet containing;
an EMF emitter proximate to a porous material powered by an EMS, wherein;
the EMF emitter proximate to a porous material radiates an EMF suitable for generating a plasma within the porous material;
an EMS which optionally pulses and modulates the EMF;
an optional chemical configuration of the porous material to enhance absorption of the EMF;
an optional geometric configuration of the porous material to optimize gas residence time in the EMF;
an adsorption bed downstream of the porous material; and
an optional vacuum source situated downstream from the adsorption bed.

2. The gas-phase reactor of claim, wherein dissociation is achieved using both plasma and pyrolysis.

3. The porous material of claim wherein the porous material is Boron Nitride.

4. The gas-phase reactor of claim, wherein the porous material is comprised of particles or pellets.

5. The gas-phase reactor of claim in which the porous material is configured to directly absorb the EMF.

6. The gas-phase reactor of claim, wherein the EMF emitter operates at 100 KHz to 1 MHz.

7. The gas-phase reactor of claim, wherein each EMF emitter operates at 300 MHz to 10 GHz.

8. The gas-phase reactor of claim wherein the ceramic housing has a high dielectric constant.

9. The gas-phase reactor of claim, wherein; the adsorption bed downstream of the porous material comprises calcium carbonate.

10. The gas-phase reactor of claim, wherein ratio of pyrolytic dissociation to plasma-induced dissociation can be tailored.

11. A method for using a gas-phase reactor for dissociating gas-phase molecules, comprising:
a metallic housing surrounding a ceramic housing surrounding;
an interior passageway with a gas inlet and a gas outlet containing;
an EMF emitter proximate to a porous material powered by an EMS, wherein;
the EMF emitter proximate to a porous material radiates an EMF suitable for generating a plasma within the porous material;
an EMS which optionally pulses and modulates the EMF;
an optional chemical configuration of the porous material to enhance absorption of the EMF;
an optional geometric configuration of the porous material to optimize gas residence time in the EMF;
an adsorption bed downstream of the porous material; and
an optional vacuum source situated downstream from the adsorption bed;
to achieve greater than 99.99% dissociation and adsorption of the gas-phase molecules.
